(19) United States
(12) Patent Application Publication
(10) Pub. No.: US 2005/0003045 A1
(43) Pub. Date: Jan. 6, 2005

(54) Manufacturing method of uncooked food and uncooked food manufactured thereby

(76) Inventors: Hee-Kyong Bae, Gyeonggi-do (KR); Yoon-Hee Whang, Seoul (KR); Jin-Hee Lee, Seoul (KR); Jae-kag Lim, Seoul (KR)

Correspondence Address: SWANSON & BRATSCHUN L.L.C., 1745 SHEA CENTER DRIVE, SUITE 330, HIGHLANDS RANCH, CO, 80129, US

(21) Appl. No.: 10/496,604

(22) PCT Filed: Dec. 20, 2002
(86) PCT No.: PCT/KR02/02395

(30) Foreign Application Priority Data
Dec. 19, 2001 (KR) 10-2001-0081351

(51) Int. Cl. A23K 1/00

(52) U.S. Cl. 426/52

(57) ABSTRACT

The present invention related to a manufacturing method of uncooked food and uncooked food manufactured thereby with improved taste and conservation period not by heating but using lactic ferments that can eradicate microorganism existing in grain, fruit and vegetables, and the method for preparing uncooked food that comprises the steps of pre-treating foods made of grain, fruit or vegetables by uncooked method; and incubating said pre-treated food by mixing with solution containing method activated lactic ferments at 15˜35° C. for 0.25˜8 hours and additionally further includes the step of activating lactic ferments in the solution containing sugar such as lactose; and adding sugar such as glucose or fructose into the mixture of the processed food and the solution containing the lactic ferments during the incubating step.

### TECHNICAL FIELD

The present invention relates to a manufacturing method of uncooked food and uncooked food manufactured thereby. More particularly, in manufacturing uncooked food made of grain, fruit or vegetables, the present invention related to a manufacturing method of uncooked food and uncooked food manufactured thereby, which is manufactured not by heating treatment but by using lactic ferments, and have improved taste and conservation period by annihilating the microorganism existing in grain, fruit and vegetables in the presence of lactic ferments.

### BACKGROUND

In case of the conventional uncooked food, there are serious problems in eradicating microorganism. Because the uncooked food and juice of green plant that are in circulation cannot be heated, eradicating microorganism have been most difficult problems. And also, in case of irradiating radiation and adding chemicals to eradicate microorganism, the safety of product is declined. In addition, because sterilization by irradiation has not proved as a safety method, applying it onto uncooked food and juice of green plant is very dangerous.

Therefore, in order to overcome the foregoing and other disadvantages in the prior art described above, a method for making uncooked food having sterilizing effect and harmless to human body is required.

### DISCLOSURE OF THE INVENTION

The object of the present invention is to provide a manufacturing method of uncooked food and uncooked food manufactured thereby with using an effective sterilizing method applied on uncooked grain, fruit and vegetables.

Another object of the present invention is to provide a manufacturing method of uncooked food and uncooked food manufactured thereby with using a method of sterilizing microorganism (harmful bacillus) without changing its taste by inoculating the lactic ferments onto grain, fruit and vegetables.

A method for preparing uncooked food that comprises the steps of pre-treating foods made of grain, fruit or vegetables by uncooked method; and incubating said pre-treated food by mixing with solution containing activated lactic ferments at 15˜35° C. for 0.25˜8 hours and further includes the steps of activating lactic ferments in the solution containing sugar such as lactose; and adding sugar such as glucose or fructose into the mixture of the processed food and the solution containing the lactic ferments during the incubating step.

The incubating step of food made of grain is treated by incubating said pre-treated food by mixing with solution containing activated lactic ferments at 15˜35° C. for 0.5˜8 hours.

The incubating step of food made of fruit and vegetables is treated by incubating said pre-treated food by mixing with solution containing activated lactic ferments at 15˜35° C. for 0.25˜6 hours.

### BRIEF DESCRIPTION OF DRAWINGS

FIG. 1a and 1b depict the comparison of the amount of E.coli existing in the uncooked grain with the incubating step according to the present invention (Example 5 and FIG. 1b) and the uncooked grains without the incubating step (Comparison Example 1, FIG. 1a).

FIG. 2a and 2b depict the comparison of the amount of E.coli existing in the uncooked fruit and vegetables with the incubating step according to the present invention (Example 21 and FIG. 2b) and the uncooked fruit and vegetables without the incubating step (Comparison Example 2, FIG. 2a).

FIG. 3 depict the graph showing amount of E.coli existing in the grain of the present invention according to time.

FIG. 4 depict the graph showing amount of E.coli existing in the fruit and vegetables of the present invention according to time.

### BEST MODE FOR CARRYING OUT THE INVENTION

The specific embodiments are explained in detail with referring the figures as in the following.

A method for preparing uncooked food that comprises the steps of pre-treating foods made of grain, fruit or vegetables by uncooked method; and incubating said pre-treated food by mixing with solution containing activated lactic ferments at 15˜35° C. for 0.25˜8 hours.

The grain, fruit and vegetables used in the pre-treating step represent its classification of common ingested foods. That is, the gain can be understood as a common designation of the principal food and ingested food with adding on the principal food such as rice, barley, millet and bean. And also the fruit and vegetables are a common designation of the fruit comprising commonly ingested fruit such as apple and pear, and of the vegetables comprising commonly ingested vegetables with/without processing such as Chinese cabbage and radish.

Therefore, the food of the present invention is a common designation of natural food. To uncooked, conservat and circulate the food suitable for eating raw among these foods, the present invention is characterized in that the harmful bacillus is sterilized with using the sterilization power of lactic ferments thereof by dipping the uncooked foods into the solution containing lactic ferments for improving taste and conservation of the food. The uncooked method in the pre-treating step means the processes of making the raw material into the suitable form for eating raw including making it to powder by mechanical crushing and drying, and swelling by dipping into water for increasing the amount of contained water but not any heating process

The lactic ferment used in the present invention is a common designation of the lactic ferments that perform lactic fermentation. Lactic acid is obtained from lactic fermentation as a product.

The lactic ferment is selected from the disclosed group consisting of Lactobacillus fermentum, Lactobacillus confusus, Bifidobacterium infantis, Streptococcus fecalis and their mixture. The strains are just described not for limiting the present invention but for examples. The method comprises more step of lactic ferments activating that activate the lactic ferments with the solution containing sugar such as lactose. Activating of lactic ferments in solution containing sugar under the condition of proper temperature will be of course understood by those skilled in the art.

In the incubating step, the increased lactic ferments during incubation of the processed uncooked food with solution containing the activated lactic ferments at 15˜35° C. for 0.25˜8 hours suppress the growth of harmful bacillus and sterilize it at once. Having growth suppressive effect and sterilization effect against other harmful bacillus by increasing of lactic ferments will be of course understood by those skilled in the art.

In the incubating step, the processed grain that was treated by uncooked method is incubated with solution containing activated lactic ferments at 15˜35° C. for 0.5˜8 hours. And also, the processed fruit and vegetables that were treated by uncooked method are incubated with solution containing activated lactic ferments at 15˜35° C. for 0.25˜6 hours.

From the above statement, if the incubation temperature is below 15° C., the proliferation of the lactic ferments is poor due to the low temperature, and if the incubation temperature is upper 35° C., the proliferation of the harmful bacillus is greater than that of lactic ferments and result in decreasing the effect of sterilization. From the above statement, if the incubation time is shorter than 15 min, sterilization by the lactic ferments is poor, and if the incubation time is longer than 8 hours, lactic ferments start growing over proliferation and make flavor changed. However, the sourness of the food is determined by lactic ferments, in case of endowing the food with sourness, exceeding 8 hours of incubation time will be of course understood by those skilled in the art, and not to be constructed as limiting the present invention.

In the incubating step, proliferation of the lactic ferments can be maximize by adding sugar such as glucose and fructose into the mixture of the solution containing lactic ferments and the processed food by uncooked method. In general, lactic ferment is proliferated with digesting sugar and produce lactic acid. The lactic acid endows the food with sourness by increasing its pH, and suppresses the growth of, and sterilizes other microorganism.

Practical and presently preferred embodiments of the present invention are illustrative as shown in the following Examples, and not to be constructed as limiting the present invention.

### EXAMPLE 1˜16

Lactobacillus fermemtum deposited in Korean Culture Center Microorganism Incorporated Association (KMCCM-10251) located in 134, Shinchon-dong, Seodaemoon-gu, Seoul, Korea with accession number KCCM-10251 was distributed. And also, Lactobacillus confusus, Bipidobacterium infantis and Streptococus fecalis were distributed from Seoul Women's University located in Seoul, Korea. These distributed frozen-dried lactic ferments were inoculated onto unhulled rice, which was swelled in water for a day. After then, annihilation time of E.coli existing in each unhulled rice (Lactobacillus fermemtum (Example 1), Lactobacillus confusus (Example 2), Bipidobacterium infantis (Example 3), Streptococus fecalis (Example 4)) was measured at 30° C., and their results were described in table 1.

And the lactic ferments activated in solution containing 3% of lactose were inoculated onto unhulled rice, which was swelled in water for a day. After then, annihilation time of E.coli existing in each unhulled rice (Lactobacillus fermemtum (Example 5), Lactobacillus confusus (Example 6), Bipidobacterium infantis (Example 7), Streptococus fecalis (Example 8)) was measured at 30° C., and its result was described in table 1.

With the same method as described above excepting incubation temperature, the distributed frozen-dried lactic ferments were inoculated onto unhulled rice. After then, annihilation time of E.coli existing in each unhulled rice (Lactobacillus fermemtum (Example 9), Lactobacillus confusus (Example 10), Bipidobacterium infantis (Example 11), Streptococus fecalis (Example 12)) was measured at 20° C., and also the lactic ferments which were activated in solution containing 3% of lactose was inoculated onto unhulled rice. After then, annihilation time of E.coli existing in each unhulled rice (Lactobacillus fermemtum (Example 13), Lactobacillus confusus (Example 14), Bipidobacterium infantis (Example 15), Streptococus fecalis (Example 16)) was measured, and their result were described in table 2.

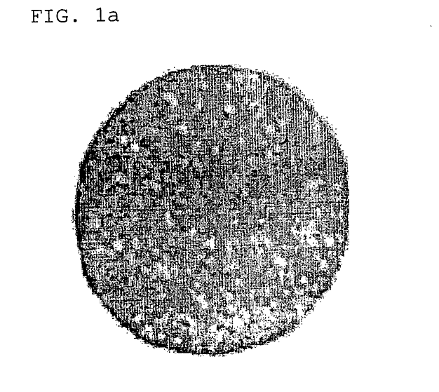

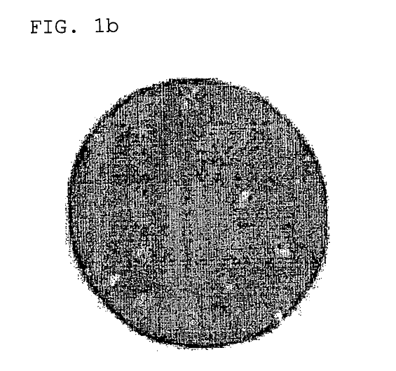

To measure the annihilation time of E.coli, Petri Film for E.coli detection (3M Corporation, USA) was used, and Comparison Example (FIG. 1a) of lactic ferments free grain which was swelled for a day, and compared with lactic ferments present Example 5 of the present invention (FIG. 1).

TABLE 1

| | Examples | | | | | | | |
|---|---|---|---|---|---|---|---|---|
| | 1 | 2 | 3 | 4 | 5 | 6 | 7 | 8 |
| Annihilation | 3 | 5 | 5 | 5 | 0.5 | 1 | 1 | 1 |
| time | | | | | | | | |

TABLE 2

| | Examples | | | | | | | |
|---|---|---|---|---|---|---|---|---|
| | 9 | 10 | 11 | 12 | 13 | 14 | 15 | 16 |
| Annihilation time | 5 | 8 | 8 | 8 | 1 | 2 | 2 | 2 |

### EXAMPLE 17˜32

The methods for preparing Example 17˜24 were the same as that of Example 1˜16 except substituting kale for unhulled rice, and their result were described in table 3 and 4. The methods including 30° C. incubation temperature for preparing Example 1˜8 were corresponded to that of Example 17˜24, and their result were described in table 3.

And also, the methods including 20° C. incubation temperature for preparing Example 9˜16 were corresponded to that of Example 25˜32, and their result were described in table 4.

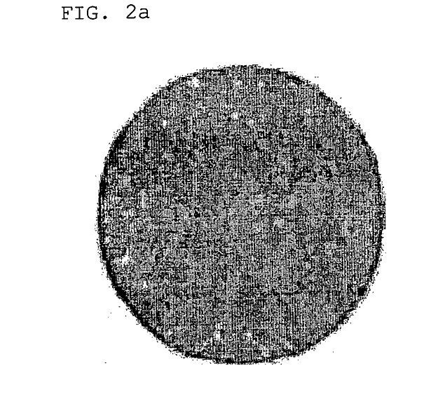

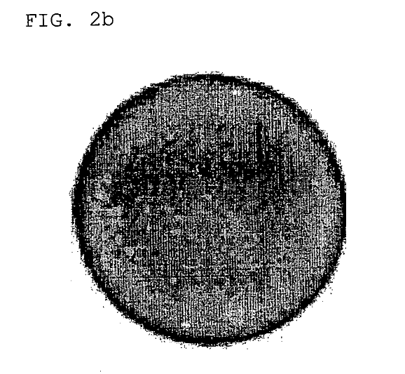

To measure the annihilation time of E.coli, Petri Film for E.coli detection (3M Corporation, USA) was used, and Comparison Example (FIG. 2a) of lactic ferments free vegetables which was swelled for a day, and compared with lactic ferments present Example 21 of the present invention (FIG. 2b).

TABLE 3

| | Examples | | | | | | | |
|---|---|---|---|---|---|---|---|---|
| | 17 | 18 | 19 | 20 | 21 | 22 | 23 | 24 |
| Annihilation time | 2 | 4 | 4 | 4 | 0.25 | 0.5 | 0.5 | 0.5 |

TABLE 4

| | Examples | | | | | | | |
|---|---|---|---|---|---|---|---|---|
| | 25 | 26 | 27 | 28 | 29 | 30 | 31 | 32 |
| Annihilation time | 3 | 6 | 6 | 6 | 0.5 | 1 | 1 | 1 |

As mentioned above, the harmful bacillus such as E.coli were sterilized effectively by regulating the incubating time of the mixture of the lactic ferments and uncooked food to be within a range of E.coli annihilating time.

As shown in FIG. 1a and 1b and FIG. 2a and 2b, in Comparison Example which were not incubated with lactic ferments, the trace of gas spouted from E.coli was present on petri film just a side of E.coli colonies. However, there was no trace of gas spouted from E.coli on petri film in Examples according to the present invention since all E.coli were annihilated.

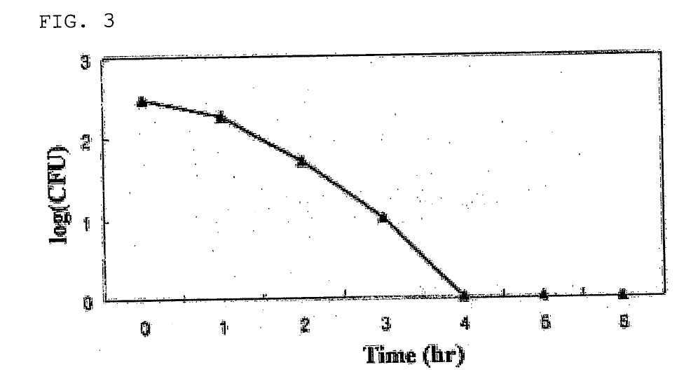

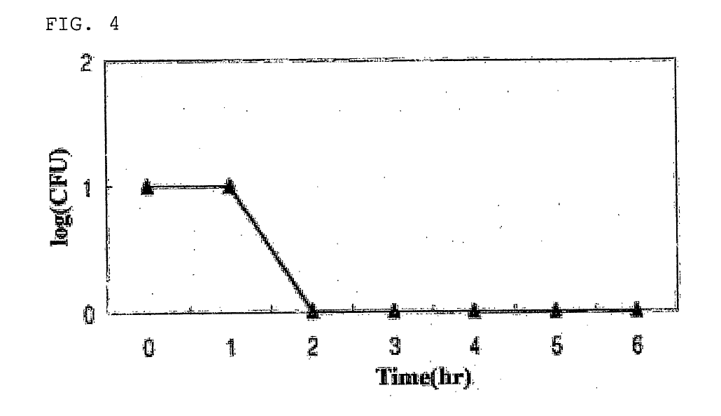

And also, as shown in FIG. 3 and 4, by referring the result of counting number of E.coli according to time, E.coli was decreased in number and finally annihilated.

### INDUSTRIAL APPLICABILITY

Consequently, the present invention has an effect of providing a manufacturing method of uncooked food and uncooked food manufactured thereby that improved the taste and conservation period by sterilizing the microorganism existing in grain, vegetables and fruit not using heat-treating process but using incubating the lactic ferments process.

The foregoing embodiments are merely exemplary and are not to be constructed as limiting the present invention. The present teachings can be readily applied to other types of devices. The description of the present invention is intended to be illustrative, and not to limit the scope of the claims. Many alternatives, modifications, and variations will be apparent to those skilled in the art.

1. A method for preparing uncooked food that comprises the steps of
pre-treating foods made of grain, fruit or vegetables by uncooked method; and
incubating said pre-treated food by mixing with solution containing activated lactic ferments at 15˜35° C. for 0.25˜8 hours.

2. The method for preparing uncooked food according to claim 1, wherein the incubating step further includes the step of adding sugar into the mixture of said pre-treated food and the solution containing the lactic ferments, which is glucose or fructose.

3. The method for preparing uncooked food according to claim 1 or 2, wherein the preparing method further includes step of activating the lactic ferments with the solution containing sugar that is lactose.

4. The method for preparing uncooked food according to claim 1 or 2, wherein the incubating step of food made of grain is treated by incubating said pre-treated food by mixing with solution containing activated lactic ferments at 15˜35° C. for 0.5˜8 hours.

5. The method for preparing uncooked food according to claim 1 or 2, wherein the incubating step of food made of fruit and vegetables is treated by incubating said pre-treated food by mixing with solution containing activated lactic ferments at 15˜35° C. for 0.25˜6 hours.

6. An uncooked food prepared by the method according to any one of method described in claim 1˜5.
